(19) United States
(12) Patent Application Publication
(10) Pub. No.: US 2026/0292890 A1
(43) Pub. Date: Sep. 24, 2026

(54) WIRELESS COMMUNICATION METHOD AND RELATED DEVICES

(71) Applicant: SHENZHEN TCL NEW TECHNOLOGY CO., LTD., Shenzhen, Guangdong (CN)

(72) Inventors: Yiwei DENG, Shenzhen, Guangdong (CN); Kai LIU, Shenzhen, Guangdong (CN); Shahid JAN, Shenzhen, Guangdong (CN)

(73) Assignee: SHENZHEN TCL NEW TECHNOLOGY CO., LTD., Shenzhen, Guangdong (CN)

(21) Appl. No.: 19/473,288

(22) PCT Filed: Apr. 7, 2023
(86) PCT No.: PCT/CN2023/087037

§ 371 Date: Oct. 7, 2025

(51) Int. Cl. H04W 74/0833

(52) U.S. Cl. CPC H04W 74/0833

(57) ABSTRACT

A wireless communication method and related devices such as a user equipment (UE) and a base station (BS) (e.g., a gNB) are provided. The wireless communication method, performed by a UE, including notifying the base station of beam information by associating the beam information with multiple physical random access channel (PRACH) transmission or random access channel (RACH) resources of the multiple PRACH transmission. With this method, cell coverage enhancement is realized.

### TECHNICAL FIELD

The present application relates to wireless communication technologies, and more particularly, to a wireless communication method, and related devices such as a user equipment (UE) and a base station (BS) (e.g., a gNB).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (B-UTRAN), for a mobile access network where one or more macro-cells are supported by base station knowns as an eNodeB or eNB (evolved NodeB). LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

In RAN #94 meeting, a new Rel-18 work item on NR coverage enhancements was approved. The objective of this work item is to study potential coverage enhancement solutions for PRACH and waveform for both FR1 and FR2. The detailed objectives are as follows.
Specify following PRACH coverage enhancements (RAN1, RAN2)
   Multiple PRACH transmissions with same beams for 4-step RACH procedure
   Study, and if justified, specify PRACH transmissions with different beams for 4-step RACH procedure
   Note 1: The enhancements of PRACH are targeting for FR2, and can also apply to FR1 when applicable.
   Note 2: The enhancements of PRACH are targeting short PRACH formats, and can also apply to other formats when applicable.
Study and if necessary specify following power domain enhancements
   Enhancements to realize increasing UE power high limit for CA and DC based on Rel-17 RAN4 work on “Increasing UE power high limit for CA and DC”, in compliance with relevant regulations
      Note 1: The study starts after RAN4 work on “Increasing UE power high limit for CA and DC” is done depending on conclusions from RAN4.
      Note 2: The objective will be revisited and further clarified in RAN plenary after RAN4 work on “Increasing UE power high limit for CA and DC” is done, and the discussion in WGs will not start before the objective is revised with a clearer scope.
      Note 3: Both RAN1 and RAN4 are expected to be involved; to decide the order of either (RAN4, RAN1) or (RAN1, RAN4) later.
   Enhancements to reduce MPR/PAR, including frequency domain spectrum shaping with and without spectrum extension for DFT-S-OFDM and tone reservation
Specify enhancements to support dynamic switching between DFT-S-OFDM and CP-OFDM

Coverage is one of the key factors that an operator considers when commercializing cellular communication networks due to its direct impact on service quality as well as capital expenditure (CAPEX) and operational expenditure (OPEX). Despite the importance of coverage on the success of NR commercialization, a thorough coverage evaluation and a comparison with legacy radio access technologies (RATs) considering all NR specification details have not been done up to now.

Compared to LTE, New Radio (NR) is designed to operate at much higher frequencies such as 28 GHz or 39 GHz in FR2. Furthermore, many countries are making available more spectrums on FR1, such as 3.5 GHz, which is typically in higher frequencies than that for LTE or 3G. Due to the higher frequencies, it is inevitable that the wireless channel will be subject to higher path-loss, making it more challenging to maintain an adequate quality of service that is at least equal to that of legacy RATs. One key mobile application of particular importance is voice service for which a typical subscriber will always expect a ubiquitous coverage wherever s/he is.

For FR1, NR can be deployed either in newly allocated spectrums, such as 3.5 GHz, or in a spectrum re-farmed from a legacy network, e.g., 3G and 4G. In either case, coverage will be a critical issue considering the fact that these spectrums will most likely handle key mobile services such as voice and low-rate data services. For FR2, coverage was not thoroughly evaluated during the self-evaluation campaign towards IMT-2020 submission and not considered in 3GPP Rel-16 enhancements. In these regards, a thorough understanding of NR coverage performance is needed while taking into account the support of latest NR specification.

In RAN #94 meeting, a new 3GPP Rel-18 work item on NR coverage enhancements was approved. The objective of this study item is to study potential coverage enhancement solutions for specific scenarios for both FR1 and FR2. Some potential methods for coverage enhancement have been discussed in the previous RAN1 meetings; however, there are still some issues that need to be enhanced.

### SUMMARY

The objective of the present application is to provide a wireless communication method and related devices, for realizing cell coverage enhancement.

In a first aspect, an embodiment of the present application provides a wireless communication method, performed by a user equipment (UE), the method including: notifying a base station of beam information by associating the beam information with multiple physical random access channel (PRACH) transmission or random access channel (RACH) resources of the multiple PRACH transmission.

In a second aspect, an embodiment of the present application provides a wireless communication method, performed by a user equipment (UE), the method including: notifying a base station of the number of repetition of multiple physical random access channel (PRACH) transmission.

In a third aspect, an embodiment of the present application provides a wireless communication method, performed by a user equipment (UE), the method including: transmitting multiple physical random access channel (PRACH) transmission on random access channel (RACH) occasions (ROs), wherein a synchronization signal/physical broadcast channel (PBCH) block (SSB) index is mapped to a set ROs with different time location in time domain.

In a fourth aspect, an embodiment of the present application provides a wireless communication method, performed by a base station (BS), the method including: being notified of beam information by associating the beam information with multiple physical random access channel (PRACH) transmission or random access channel (RACH) resources of the multiple PRACH transmission.

In a fifth aspect, an embodiment of the present application provides a wireless communication method, performed by a base station (BS), the method including: being notified of the number of repetition of multiple physical random access channel (PRACH) transmission.

In a sixth aspect, an embodiment of the present application provides a wireless communication method, performed by a base station (BS), the method including: receiving multiple physical random access channel (PRACH) transmission on random access channel (RACH) occasions (ROs), wherein a synchronization signal/physical broadcast channel (PBCH) block (SSB) index is mapped to a set ROs with different time location in time domain.

In a seventh aspect, an embodiment of the present application provides a user equipment (UE), including a processor, configured to call and run program instructions stored in a memory, to execute any of the methods of the first aspect to the third aspect.

In an eighth aspect, an embodiment of the present application provides a base station (BS), including a processor, configured to call and run program instructions stored in a memory, to execute any of the methods of the fourth aspect to the sixth aspect.

In a ninth aspect, an embodiment of the present application provides a computer readable storage medium provided for storing a computer program, which enables a computer to execute the method of any of the first aspect to the sixth aspect.

In a tenth aspect, an embodiment of the present application provides a computer program product, which includes computer program instructions enabling a computer to execute the method of any of the first aspect to the sixth aspect.

In an eleventh aspect, an embodiment of the present application provides a computer program, when running on a computer, enabling the computer to execute the method of any of the first aspect to the sixth aspect.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram illustrating misalignment between gNB and UE.

FIG. 2 is a block diagram of a user equipment and a base station of wireless communication in a communication controlling system according to an embodiment of the present application.

FIG. 3 is a schematic diagram illustrating radio protocol architecture within gNB and UE.

FIG. 4 is a schematic diagram illustrating a gNB further including a centralized unit (CU) and a plurality of distributed unit (DUs).

FIG. 5 is a flowchart of a wireless communication method according to an embodiment of the present application.

FIG. 6 is a schematic diagram illustrating an example of UE's beam index indicated by ROs.

FIG. 7 is a schematic diagram illustrating an example of beams associated with ROs.

FIG. 8 is a schematic diagram illustrating another example of beams associated with ROs.

FIG. 9 is a flowchart of a wireless communication method according to another embodiment of the present application.

FIG. 10 is a schematic diagram illustrating the repetition number of PRACH associated with resources of RO5.

FIG. 11 is a schematic diagram illustrating a RO set indicating repetition number of PRACH.

FIG. 12 is a flowchart of a wireless communication method according to still another embodiment of the present application.

FIG. 13 is a schematic diagram illustrating SSB mapping to a set of ROs of PRACH.

FIG. 14 is a schematic diagram illustrating SSB mapping to whole ROs in time domain of a RACH configuration.

FIG. 15 is a schematic diagram illustrating SSB mapping based on the number of PRACH repetition.

### DETAILED DESCRIPTION OF EMBODIMENTS

Embodiments of the application are described in detail with the technical matters, structural features, achieved objects, and effects with reference to the accompanying drawings as follows. Specifically, the terminologies in the embodiments of the present application are merely for describing the purpose of the certain embodiment, but not to limit the application.

In this document, the term “/” should be interpreted to indicate “and/or.” A combination such as “at least one of A, B, or C,” “one or more of A, B, or C,” “at least one of A, B, and C.” “one or more of A, B, and C,” or “A, B, and/or C” may be A only, B only, C only, A and B, A and 30 C, B and C, or A and B and C, where any combination may contain one or more members of A, B, or C.

In current 3GPP specification, for initial access procedure, gNB broadcasts the system information based on different synchronization signal/PBCH blocks (SSBs), and the information of beam index which is indicated by the different demodulation reference signal (DMRS) and explicitly employs 3 bits in master information block (MIB). Similarly, in a case of multiple physical random access channel (PRACH) transmission with more than one beam, the beam information (e.g. beam index) can be carried by Msg 1 to avoid ambiguity between gNB and UE. In this case, the maximum number of beams can be limited or pre-defined, e.g. the maximum number of beams at UE side is not bigger than the number of repetition of PRACH or can be pre-defined with a value. In this case, whether UE needs to support transmission of multiple PRACH with more than one beams needs to be configured, e.g. by MIB/SIB 1 or be configured within RACH-ConfigCommon or RACH-ConfigGeneric. To further improve the coverage capacity of multiple PRACH, more than one beams can be used for multiple PRACH transmission since this achieves more array gain. In addition, in R-17, Msg3 is also a coverage bottleneck channel. In the case of multiple PRACH transmissions with more than one beam, to further improve the coverage capacity of Msg3 and/or Msg5 (which carries an acknowledgement), whether to associate the multiple beams with msg3, msg5 needs to be studied. If the better beams are used for Msg 3 and/or Msg 5 transmission, then the coverage capacity of Msg 3 and/or Msg 5 transmission will be improved. Thus, how to determine the better/best beam for Msg3 and/or Msg5 transmission is needed to be addressed. In addition, to avoid the ambiguity between gNB and UE, similar to SSB index, the beam index of UE needs to be indicated to gNB.

The foregoing can be summarized as 1) how to indicate the beam index to gNB; and 2) how to determine/indicate the better/best beam in Msg 3 and/or Msg 5 transmission.

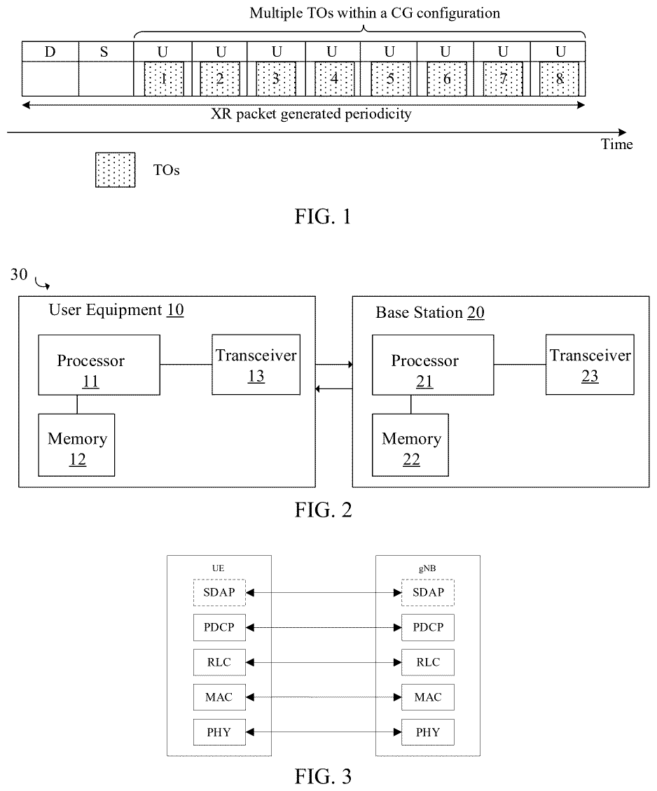

It has been agreed that more than one value for multiple PRACH transmission is supported, e.g. 2, 4, 8. However, which value within a set of candidate values of repetition can be used for UE is not clear yet. One way is that gNB indicates the number of repetition to UE. In this way, it's difficult to indicate due to the SIB1 is a cell common information and all of the UEs within the cell may detect the information. Another feasible way is that the UE can determine the number of repetition based on certain rules, e.g. based on reference signal received power (RSRP) of SSB or based on UE implementation. However, these mechanisms to determine the number of repetition of PRACH is unknown for the gNB. So from gNB's side, the actual number of repetition of PRACH is based on blind detection. When the gNB detects a PRACH preamble correctly, the gNB can stop detecting PRACH preamble and transmit a random access response (RAR) to UE, and UE needs to detect the RAR within a RAR window. However, UE does not know when gNB detects PRACH preamble correctly. Accordingly, there will have some misalignment between gNB and UE. For instance, as shown in FIG. 1, UE determines to transmit 8 repetition of PRACH to gNB and occupies the resources of RACH occasion 2 (RO2) to RO9, and UE expects to monitor the RAR based on RO9. However, at the fifth repetition of PRACH (RO6), gNB detects the PRACH preamble correctly. Since gNB doesn't know actual number of PRACH of UE transmission, gNB may start the RAR based on RO6. However, this is not the UE's expected location to detect the RAR (RAR grant and RAR message). The RAR will be lost due to the misalignment. Thus, a mechanism to address the alignment of the start of RAR window is needed.

The foregoing can be summarized as how to handle misalignment between gNB and UEs for starting point of RAR window.

In current 3GPP specification, the mapping rule between SSBs and RACH occasions (ROs) is based on frequency first mapping, as shown in the following:

SS/PBCH block indexes provided by ssb-PositionsInBurst in SIB1 or in ServingCellConfigCommon are mapped to valid PRACH occasions in the following order where the parameters are described in [4, TS 38.211].
First, in increasing order of preamble indexes within a single PRACH occasion
Second, in increasing order of frequency resource indexes for frequency multiplexed PRACH occasions
Third, in increasing order of time resource indexes for time multiplexed PRACH occasions within a PRACH slot
Fourth, in increasing order of indexes for PRACH slots

However, some ROs for an attempt of RACH transmission will be linked to more than one beam, where the attempt of RACH transmission is a PRACH transmission with repetition. However, more than one beam indicated by a RACH attempt transmission will cause an ambiguity between gNB and UE, and gNB will not know which beam is the best or better beam for UE reception. When UE wants to use multiple ROs with different entities of time to transmit a RACH attempt with PRACH repetition and the attempt RACH transmission is carried by more than one beam, this will cause ambiguity for the gNB, and the eNB will not know which SSB is the best of better beam for the UE. Therefore, a new rule for SSB-TO-RO mapping should be studied.

The foregoing can be summarized as how to design a mapping rule between ROs and SSBs.

In Rel-17, PRACH coverage enhancement has not been addressed, despite being identified as one of the bottleneck channels in corresponding studies. PRACH transmission is very important for many procedures, e.g., initial access and beam failure recovery. To achieve better coverage performance, some enhancement methods will be needed. This disclosure proposes some coverage enhanced methods for PRACH channel. With these methods, better coverage will be achieved for uplink channel.

FIG. 2 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal. The base station 20 and a next generation core network (5GCN) may also communicate with each other either wirelessly or in a wired way. When the communication network system 30 complies with the New Radio (NR) standard of the 3rd Generation Partnership Project (3GPP), the next generation core network is a backend serving network system and may include an Access and Mobility Management Function (AMF), User Plane Function (UPF), and a Session Management Function (SMF) In one aspect, the user equipment 10 can include almost any consumer electronic device or appliance that can connect to a radio access network and a core network for the releases of 3GPP and further, such as, but not limited to NR networks.

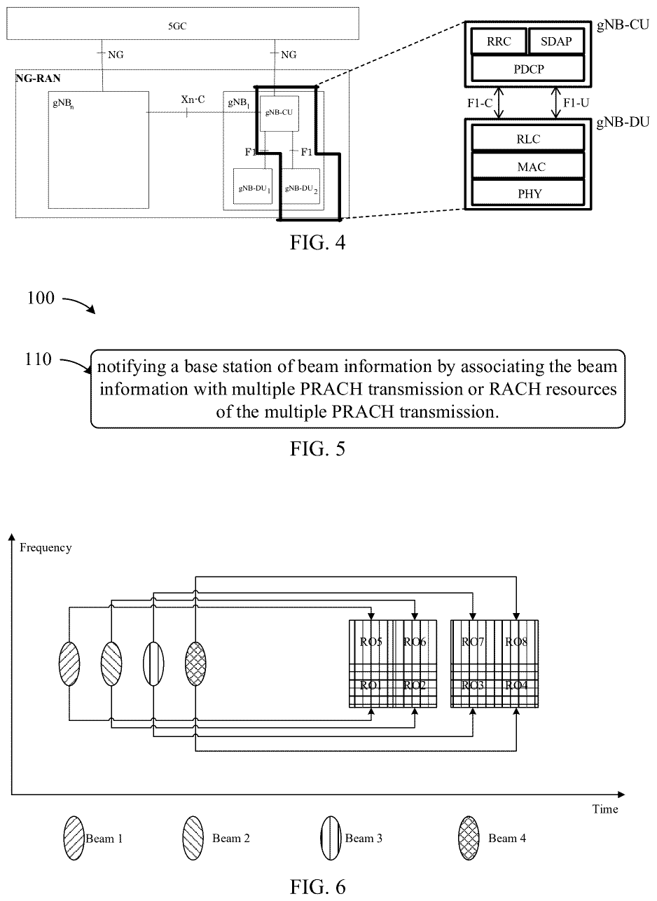

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art. The user plane radio protocol architecture within the gNB and UE is shown in FIG. 3, which includes optional Service Data Adaptation Protocol (SDAP), Packet Data Convergence Protocol (PDCP), Radio Link Control (RLC), Medium Access Control (MAC). In RAN functional split, a gNB further includes a centralized unit (CU) and a plurality of distributed unit (DUs) as shown in FIG. 4. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer and the RLC layer.

FIG. 5 illustrates a wireless communication method according to an embodiment of the present application. Referring to FIG. 5 in conjunction with FIG. 2, the method 100 includes the following. In Step 110, the UE notifies the base station of beam information by associating the beam information with multiple physical random access channel (PRACH) transmission or random access channel (RACH) resources of the multiple PRACH transmission. The beam information may be beam index or beam number or maximum number of beams. With this method, cell coverage enhancement is realized.

In an embodiment, the beam information may be indicated by time/frequency resources of RACH occasions (ROs) of the multiple PRACH transmission. A mapping rule between the RO and the beam information may be pre-defined. A set of consecutive ROs or non-consecutive ROs in time or frequency domain may be mapped to a beam index of the beam information. In another embodiment, the beam information may be associated with the number of repetition of the multiple PRACH transmission. The number of the multiple PRACH transmission may be equal to the number of beams, and a location of repetition or a repetition number within the multiple PRACH transmission may be used to indicate a beam index of the beam information. In still another embodiment, the beam information may be determined based on a RO group, which may be determined based on a number of repetition of the multiple PRACH transmission and a maximum number of beams or the number of beams.

In some embodiments, the ROs and/or preambles for the multiple PRACH transmission may be used to indicate UE capacity. In some embodiments, the method may further include receiving a signalling used to notify the UE that the multiple PRACH transmission with more than one beam is enabled. In some embodiments, the method may further include being notified by the base station of an index of a beam by at least one of the following: a field in random access response (RAR); random access (RA)-radio network temporary identifier (RNTI); demodulation reference signal (DMRS) of RAR, or time domain resource allocation (TDRA) in downlink control information (DCI) of RAR or TDRA of Msg 3 or modulation and coding scheme (MCS) field of Msg 3.

Further details on how to indicate the beam index to gNB are described as follows.

This disclosure proposes method(s) to indicate the beam information (e.g. beam index or beam number or maximum number of beams) from the UE to gNB. The beam indexes of UE can be coupled with multiple PRACH transmission and/or ROs and/or RACH resources and/or repetition number of multiple PRACH transmission. In current 3GPP specification, for initial access procedure, gNB broadcasts the system information based on different SSBs, and the information of beam index which is indicated by the different DMRS and employs explicitly 3 bits in MIB. Similarly, in a case of multiple PRACH transmission with more than one beam, the beam information (e.g. beam index) can be carried by Msg 1 to avoid ambiguity between gNB and UE. In this case, the maximum number of beams can be limited or pre-defined, e.g. the maximum number of beams at UE side is not bigger than the number of repetition of PRACH or can be pre-defined with a value. In this case, whether UE needs to support transmission multiple PRACH with more than one beam needs to be configured, e.g. by MIB/SIB 1 or be configured within RACH-ConfigCommon or RACH-ConfigGeneric. The following mechanism can be considered for indicating the beam index of UE side.

In a first possible solution of the present application, the beam information can be indicated by the time/frequency resources of ROs. A mapping rule between RO and the beam information (e.g. beam index) can be pre-defined. Each beam of the UE can be indicated by a RO. For instance, as shown in FIG. 6, it is assumed that the maximum number of beams of UE is 4 and UE transmits multiple PRACH with 4 SSBs, denoted as beam1 (SSB 1), beam2 (SSB2), beam3 (SSB3) and beam4 (SSB4), and corresponding valid ROs can be used for UE are {RO1, RO2, RO3, RO4, RO5, RO6, RO7, RO8}. Then, SSB1 maps to RO1 and RO5, SSB2 maps to RO2 and RO6, SSB3 maps to RO3 and RO7, SSB4 maps to RO4 and RO8. In some cases, a beam index mapping to one RO or a set of ROs means the beam index can be indicated by the RO implicitly. In this case, the index of RO's order is time first, then frequency.

In some embodiments, a beam can be mapped to a set of consecutive or non-consecutive ROs in time of frequency domain, then the set of ROs can be used to indicate the beam index.

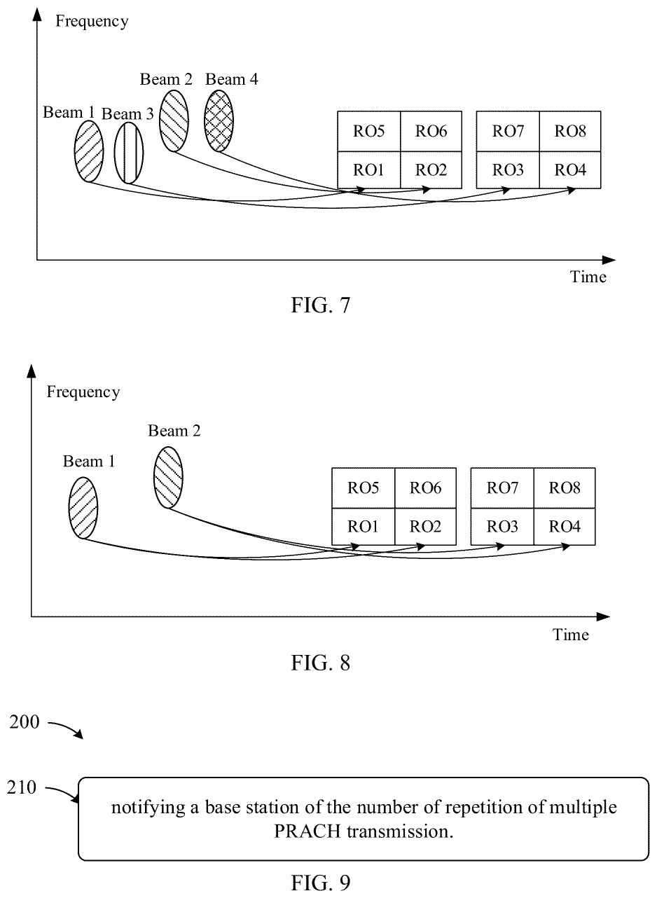

In a second possible solution of the present application, the beam index can be indicated by the repetition number of multiple PRACH transmission. In other words, the number of PRACH is equal to the number of beams and the location of the repetition or a repetition number is used to indicate the beam index. gNB can identify beam index based on the corresponding location of a repetition or a repetition number within the multiple PRACH transmission. For instance, as shown in FIG. 7, it is assumed that the number of repetition of PRACH is equal to 4, and the PRACH is transmitted over {RO1, RO2, RO3, RO4}. Then, the UE can use the first beam to transmit PRACH over RO1, use the second beam to transmit PRACH over RO2, use the third beam to transmit PRACH over RO3 and use the fourth beam to transmit PRACH over RO4. It is denoted that the first beam is beam 1 and its corresponding beam index is 1, the second beam is beam 2 and its corresponding beam index is 2, the third beam is beam 3 and its corresponding beam index is 3, and the fourth beam is beam 4 and its corresponding beam index is 4. When gNB receives any one of repetition of PRACH, the corresponding beam index can be identified.

In a third possible solution of the present application, introduce a maximum number of beams at the UE side. The beam index is determined based on the number of repetition of PRACH and the maximum number of beams. In this case, P is the maximum number of repetition of PRACH when multiple PRACH transmission is enabled. The UE shall determine the RO group (ROG) which is used to carry a beam as following:

$$M = min ( N , P )$$

where N is the number of beams or the actual transmission beams at UE side, P is the maximum number of repetition of PRACH, and ROG means RO group, which includes more than one RO.

Define M1=mod (P, M), K1=ceil (C/M), and K2=floor (C/M).

For example, if M1>0, ROG m, m=0, 1, . . . , M1-1, consists of ROG with indices m·K₁+k, k=0, 1, . . . , K₁-1 ROG m=M, M₁, M₁+1, . . . , M-1, consists of RO for repetition with indices M₁·K₁+(m−M₁)·K₂+k, k=0, 1, . . . , K₂-1. Then each beam within the multiple beams can be mapped to a ROG. In other words, a ROG within the multiple ROs for multiple PRACH transmission can carry a beam index.

For instance, as shown in FIG. 8, it is assumed that a UE transmits 4 PRACHs over {RO1, RO2, RO3, RO4} with 2 beams, denoted as beam1 and beam2. Then, the beam index can be indicated by ROG implicitly. In other words, one beam of the UE can be mapped to a ROG. In this case, RO1 and RO2 can be regarded as ROG1, and RO3 and RO4 can be regard as ROG2. Then, beam 1 maps to ROG1, and beam 2 maps to ROG2. In other words, UE uses beam 1 to transmit RACH preamble over RO1 and RO2, and UE uses beam 2 to transmit RACH preamble over RO3 and RO4. When gNB detects the RACH preambles at the RO1 or RO2, gNB can know the corresponding beam from UE side is beam1. When gNB detects the RACH preambles at the RO3 or RO4, gNB can know the corresponding beam from UE side is beam2.

In some embodiments, UE capacity (UE's radio frequency (RF) chain, antenna ports, etc.) can be indicated by the ROs and/or preambles of PRACH. The ROs and/or preamble for multiple PRACH transmission can be grouped into more than one, different groups and are used to indicate the UE capacity.

Further details on how to determine/indicate the better/best beam in Msg 3 and/or Msg 5 transmission are described as follows.

This disclosure proposes method(s) to indicate the index of better/best beam to UE. The beam index can be indicated by RAR or some other parameters related to RAR or MSG 3. In current 3GPP specification, for RACH procedure, UE chooses a RO for a preamble randomly based on the better/best SSB to transmit PRACH, and the best SSB is indicated by the RO and/or preamble implicitly. In a case that it is enabled that the UE can transmit multiple PRACH with more than one beam, after UE transmits multiple PRACH and gNB detects the RACH preamble correctly, gNB needs to transmit a RAR (random access response) to UE for the UE to detect the RAR within a RAR window. The RAR information can carry the information of the index of better/best beam or preamble index or repetition location or which number of repetition. The following solutions can be considered.

In a first possible solution of the present application, a new field in RAR can be introduced to indicate the index of better/best beam of UE. The size of the new field in RAR can be determined based on the maximum number of SSBs or the total number of beams or the actual beams. For example, it is assumed that the field size is 2, then “00” can indicate the beam index 1, “01” can indicate the beam index 2, “10” can indicate the beam index 3, “11” can indicate the beam index 4.

In a second possible solution of the present application, indicate by random access (RA)-radio network temporary identifier (RNTI). Different RA-RNTI can be used to indicate the index of better/best beam of UE. In this case, the beam index can be used to determine RA-RNTI, and the RA-RNTI formula can be defined as follows:

$$RA - RNTI = 1 + s\_id + 14 \times t\_id + 14 \times 80 \times f\_id + 14 \times 80 \times 8 \times ul\_carrier \_id = beam\_index .$$

where s_id is the index of the first OFDM symbol of the last PRACH occasion or any one PRACH occasion within a RO set which is used for an attempt of multiple PRACH transmission (0≤s_id<14), t_id is the index of the first slot of the PRACH occasion in a system frame (0≤t_id<80), where the sub-carrier spacing to determine t_id is based on the value of a specified in TS 38.211 for μ={0, 1, 2, 3}, and for μ={5, 6}, t_id is the index of the 120 kHz slot in a system frame that contains the PRACH occasion (0≤t_id<80), f_id is the index of the PRACH occasion in the frequency domain (0≤f_id<8), and ul_carrier_id is the UL carrier used for Random Access Preamble transmission (0 for NUL carrier, and 1 for SUL carrier), and the beam_index is the number of UE's beams for multiple PRACH transmission.

In some embodiments, when the multiple PRACH transmission with one beam, then the element of beam index can be 0.

In some embodiments, to avoid ambiguity between UE and gNB, a signalling used to enable or disable the multiple PRACH transmission with more than one beam. When more than one Tx beam from UE side is enabled, the UE needs to detect RAR with more than one RA-RNTI. The total number of times of detection is equal to the number of the beams at the UE side. Anyway, for a UE using a single beam to transmit multiple PRACHs, UE needn't to detect more than one RA-RNTI scrambled PDCCH for RAR. gNB needs to know whether UE transmits multiple PRACH with more than one beam, and thus corresponding RA-RNTI can be aligned between gNB and UE sides. A new signalling or a new parameters within SIB1 can be used to indicate whether UE enables multiple PRACH transmission with more than one beam or not.

In a third possible solution of the present application, indicate by the demodulation reference signal (DMRS) of RAR. Different DMRS sequences or DMRS port can be used to indicate the beam index of UE's better/best beam. For example, a set of DMRS sequences can be used for RAR, and each DMRS within the DMRS set can be used to indicate one beam index to UE. For instance, it is assumed that there are 4 different DMRS that can be used, denoted as {DMRS1, DMRS2, DMRS3, DMRS4}. Then, a RAR with DMRS1 can be used to indicate beam index 1, a RAR with DMRS2 can be used to indicate beam index 2, a RAR with DMRS3 can be used to indicate beam index 3, and a RAR with DMRS4 can be used to indicate beam index 4.

In a fourth possible solution of the present application, indicate by the time domain resource allocation (TDRA) in downlink control information (DCI) of RAR or indicate by the TDRA of Msg 3 or modulation and coding scheme (MCS) field of Msg 3. For example, add a new column at the time domain resource table of PDSCH of RAR or time domain resource table or MCS of Msg 3, and the new column is used to indicate the beam index.

FIG. 9 illustrates a wireless communication method according to another embodiment of the present application. Referring to FIG. 9 in conjunction with FIG. 2, the method 200 includes the following. In Step 210, the UE notifies the base station of the number of repetition of multiple physical random access channel (PRACH) transmission. In some embodiments, the method may further includes determining a random access response (RAR) window based on the number of repetition of the multiple PRACH transmission. In the RAR window determining step, the RAR window may be started based on a reference point plus an offset value. With this method, cell coverage enhancement is realized.

In an embodiment, in the notifying step, the number of repetition of the multiple PRACH transmission may be indicated based on random access channel (RACH) occasion (RO) resources of the multiple PRACH transmission. The ROs for the multiple PRACH transmission may be split into more than one part, and each part of the ROs may be associated with one level of repetition of the multiple PRACH transmission. A set of RACH occasion groups (ROGs) may be configured, and each ROG may be associated with one level of repetition of the multiple PRACH transmission. In another embodiment, in the notifying step, the number of repetition of the multiple PRACH transmission may be indicated based on RACH preamble. The RACH preambles used for the multiple PRACH transmission may be split into a plurality of groups, and each group of the RACH preambles may be associated with one level of repetition of the multiple PRACH transmission. In still another embodiment, in the notifying step, the number of repetition of the multiple PRACH transmission may be indicated based on both RACH preamble and RO resources of the multiple PRACH transmission.

Further details on how to handle misalignment between gNB and UEs for starting point of RAR window are described as follows.

This disclosure proposes method(s) to avoid ambiguity between gNB and UE for start point of RAR window. Indication of the number of repetition of PRACH to gNB and a pre-define rule can be used. It has been agreed that more than one value for multiple PRACH transmission is supported, e.g. 2, 4, 8. However, which value within the set of candidate values of PRACH repetition can be used for UE is not clear yet. When UE determines one of the candidate values of multiple PRACH transmission, gNB does not know which actual repetition number of UE is used. Therefore, there is an ambiguity between gNB and UE, and misalignment between UE and gNB for the start point of RAR window will be caused. The following solutions can be considered to avoid the ambiguity between gNB and UE.

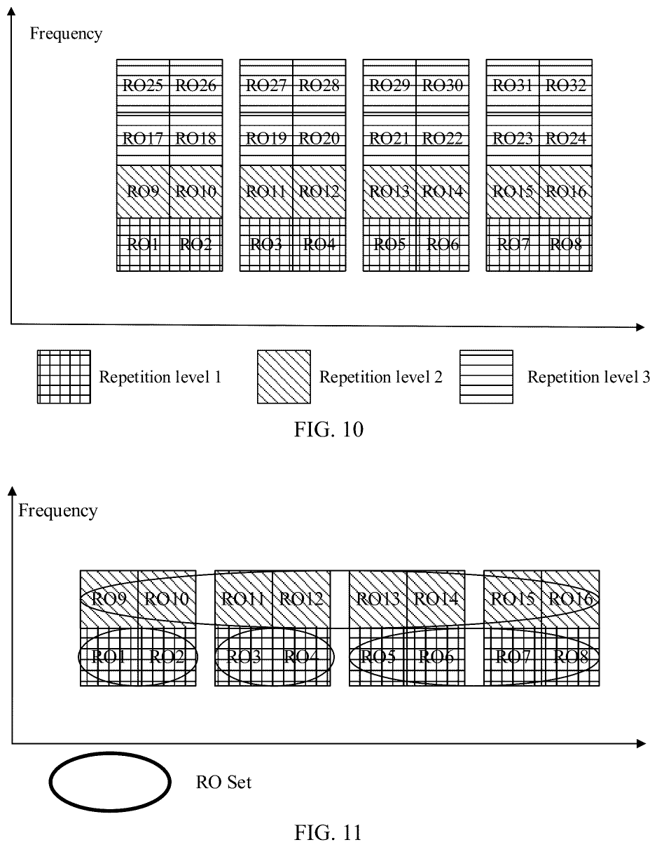

In a first possible solution of the present application, UE indicates the number of repetition of PRACH to gNB, then gNB knows the number of repetition of UE. After an attempt with the number of repetition, the RAR window can be determined based on the last RO within the multiple PRACH transmission occasions. To indicate the number of repetition to gNB, the following mechanism can be considered.
The number of PRACH repetition can be indicated based on RO resources. In other words, UE can indicate the number of repetition of PRACH to gNB based on time/frequency resources of ROs implicitly. In this case, the mapping rule between the number of multiple PRACH and ROs can be defined. The ROs for multiple PRACH transmission can be split into more than one part, and each part of the ROs can be associated with one level of repetition of the multiple PRACH transmission. For an example, as shown in FIG. 10, the ROs for multiple PRACH transmission are configured, denoted as RO1 to RO32, and all of the ROs are split into 3 parts, e.g. one part is from RO1 to RO8, denoted as part 1, one part is from RO9 to RO16, denoted as part 2, one part is from RO17 to RO32, denoted as part 3. Then, 2 repetition is associated with part 1, which means UE can choose ROs within part 1 means UE needs to repeat PRACH 2 times; similarly, 4 repetition of PRACH is associated to part 2, and 8 repetition of PRACH is associated to part 3.

In some embodiments, within each part of ROs, a set of patterns used to determine the start point and/or the end point of ROs for multiple PRACH transmission are predefined.

In some embodiments, a set of ROG (RACH occasion group) can be configured, and each ROG can be used to associate with one level of repetition. For an example, as shown in FIG. 11, multiple sets of ROs are configured by gNB/SIB1, and each set of ROs can be used to indicate the number of repetition of PRACH. In some embodiments, an attempt of multiple PRACH transmission cannot be across the boundary of a set of ROs.
UE indicates the number of repetition to gNB based on RACH preamble. The preambles used for multiple PRACH transmission can be split into several group, and each group of the preambles can be used to indicate one level of PRACH repetition. For instance, the preambles for multiple PRACH can be split into 3 sets, denoted as set 1, set 2, set 3. Then, the preambles within set 1 can be used to indicate the PRACH repetition level 1 (e.g. 2 repetitions), the preambles within set 2 can be used to indicate the PRACH repetition level 2 (e.g. 4 repetitions), and the preambles within set 3 can be used to indicate the PRACH repetition level 3 (e.g. 8 repetitions).
UE indicates the number of repetition to gNB based on both RACH preamble and time and/or frequency resources of ROs to gNB. In this case, PRACH preamble first or RO resources first can be considered.

In a second possible solution of the present application, the RAR window can be started based on a reference point plus an offset value, and the offset value can be configured or the offset value can be equal to the number of repetitions, and the reference point can be pre-defined or fixed or configured. The reference point can be any one time domain RO within the ROs, which are used for multiple PRACH transmission.

In some embodiments, the RAR window start point can be at the first symbol of the earliest CORESET the UE is configured to receive PDCCH for RACH, that is at least one symbol after the last symbol of the last valid PRACH occasion or the last symbol of the last valid PRACH occasion which is detected by gNB or a last symbol of the pre-defined valid PRACH occasion.

In some embodiments, the candidate values of repetition of the multiple PRACH transmission can be indicated by SIB1 (e.g. a column can be added into the random access configurations table which is defined in TS 38.211, and the new column is used to indicate the candidate values of multiple PRACH transmission, where the candidate values of repetition of the multiple PRACH transmission can be large than one within a set (e.g. the set can be includes: 1, 2, 4, 8 repetitions)) or the candidate values of repetition of the multiple PRACH transmission can be configured in RACH-commonconfig or RACH-configDedicated or RACH-ConfigGeneric or RACH-ConfigCommonTwoStepRA or RACH-ConfigGenericTwoStepRA.

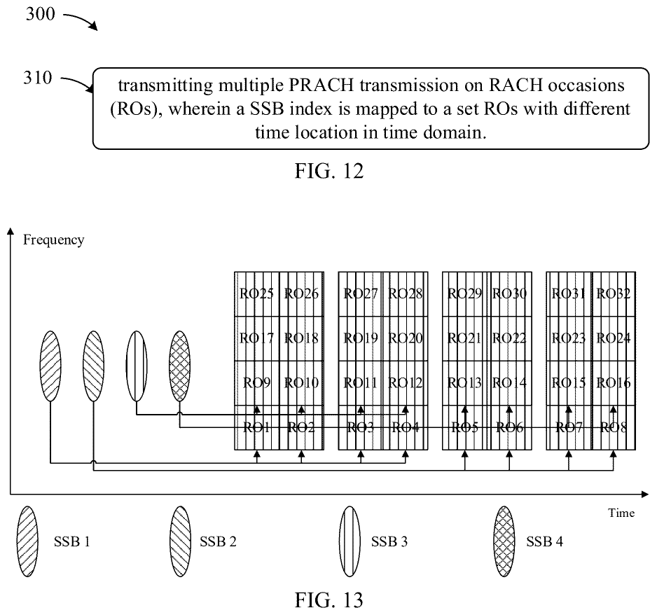

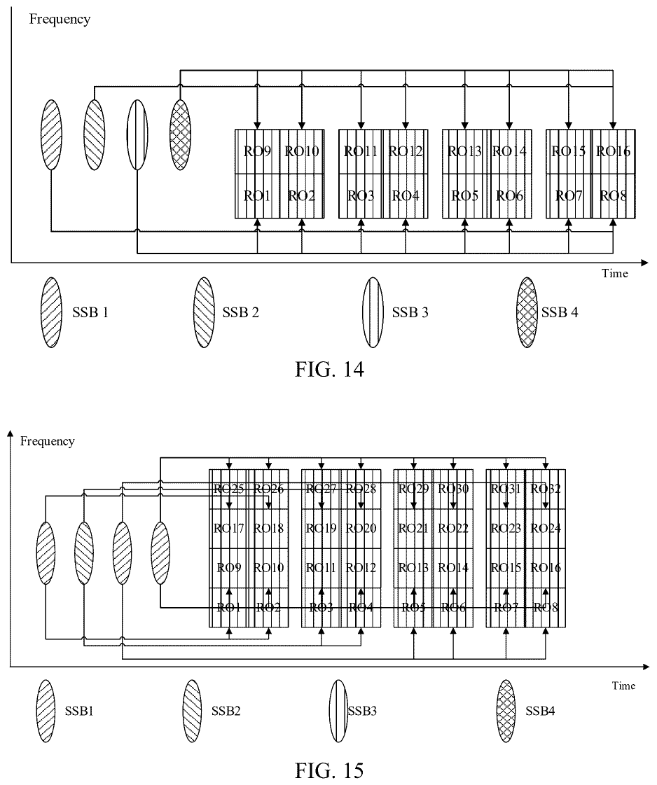

FIG. 12 illustrates a wireless communication method according to still another embodiment of the present application. Referring to FIG. 12 in conjunction with FIG. 2, the method 300 includes the following. In Step 310, the UE transmits to the base station multiple physical random access channel (PRACH) transmission on random access channel (RACH) occasions (ROs), wherein a synchronization signal/physical broadcast channel (PBCH) block (SSB) index is mapped to a set ROs with different time location in time domain. With this method, cell coverage enhancement is realized.

In an embodiment, the SSB index may be mapped to the set of time domain ROs with same or different frequency domain resources. In another embodiment, the SSB index may be mapped to whole time domain ROs of the multiple PRACH transmission within a RACH configuration. In still another embodiment, the SSB index may be mapped to a set of time domain ROs based on the number of repetition of the PRACH transmission, and the number of ROs of the set may be equal to the number of repetition of the multiple PRACH transmission.

In an embodiment, SSB indexes may be mapped to valid PRACH occasions in the following order: first, in increasing order of time resource indexes for time multiplexed PRACH occasions within a PRACH slot; second, in increasing order of indexes for PRACH slots; third, in increasing order of preamble indexes within a single PRACH occasion; fourth, in increasing order of frequency resource indexes for frequency multiplexed PRACH occasions. In another embodiment, SSB indexes may be mapped to valid PRACH occasions in the following order: first, in increasing order of time resource indexes for time multiplexed PRACH occasions within a PRACH slot, second, in increasing order of indexes for PRACH slots; third, in increasing order of frequency resource indexes for frequency multiplexed PRACH occasions; fourth, in increasing order of preamble indexes within a single PRACH occasion. In some embodiments, when more than one beam may be mapped to a set of ROs, different PRACH preamble sets are used to indicate SSB index.

Further details on how to design a mapping rule between ROs and SSBs are described as follows.

This disclosure proposes method(s) to define the mapping rule between multiple PRACH transmission and SSBs.

The SSB mapping to a set of ROs with different time and/or frequency domain can be considered. In current 3GPP spec, the mapping rule is based on a preamble-frequency-time order. The SSB to RO mapping can be configured as N-to-1, where N is pre-configured. However, based on current mechanism, more than one beam will be indicated by a RACH attempt with multiple PRACH transmission, and this will lead gNB confused to identify which beam is the best/better beam. The following proposed mechanism can be considered.

In a first possible solution of the present application, a SSB mapping to a set of time domain ROs or a set of time domain valid ROs or a set of time domain actual ROs with same or different frequency domain resources. As shown in FIG. 6, a SSB can be mapped to a set of ROs, e.g. SSB1 can be mapped to {RO1, RO2, RO3, RO4}, and the size of the set of ROs can be configured by gNB or SIB1 or RACH-commonconfig or RACH-configDedicated or RACH-ConfigGeneric or RACH-ConfigCommonTwoStepRA or RACH-ConfigGenericTwoStepRA.

In this case, SS/PBCH block (SSB) indexes provided by ssh-PositionsInBurst in SIB1 or in ServingCellConfigCommon are mapped to valid PRACH occasions in the following order:
First, in increasing order of time resource indexes for time multiplexed PRACH occasions within a PRACH slot;
Second, in increasing order of indexes for PRACH slots
Third, in increasing order of preamble indexes within a single PRACH occasion
Fourth, in increasing order of frequency resource indexes for frequency multiplexed PRACH occasions;

Alternatively,
First, in increasing order of time resource indexes for time multiplexed PRACH occasions within a PRACH slot;
Second, in increasing order of indexes for PRACH slots
Third, in increasing order of frequency resource indexes for frequency multiplexed PRACH occasions
Fourth, in increasing order of preamble indexes within a single PRACH occasion

In some embodiments, when more than one beam is mapped to a set of ROs, different PRACH preamble sets can be used to indicate the SSB information.

In a second possible solution of the present application, a SSB is mapped to whole time domain ROs of PRACH or valid ROs of PRACH or actual ROs of PRACH within a RACH configuration. For example, as shown in FIG. 7, SSB1 mapping to {RO1, RO2, RO3, RO4, RO5, RO6, RO7, RO8}, which is the whole time domain ROs of PRACH configuration. In some embodiments, when more than one beam is mapped to a set of ROs, different PRACH preamble sets can be used to indicate the SSB information.

In this case, SS/PBCH block (SSB) indexes provided by ssb-PositionsInBurst in SIB1 or in ServingCellConfigCommon are mapped to valid PRACH occasions in the following order:
First, in increasing order of time resource indexes for time multiplexed PRACH occasions within a PRACH slot;
Second, in increasing order of indexes for PRACH slots
Third, in increasing order of preamble indexes within a single PRACH occasion
Fourth, in increasing order of frequency resource indexes for frequency multiplexed PRACH occasions;

Alternatively,
First, in increasing order of time resource indexes for time multiplexed PRACH occasions within a PRACH slot;
Second, in increasing order of indexes for a set of PRACH slots
Third, in increasing order of frequency resource indexes for frequency multiplexed PRACH occasions
Fourth, in increasing order of preamble indexes within a single PRACH occasion

In a third possible solution of the present application, a SSB is mapped to a set of time domain ROs based on the number of repetition of PRACH. In other words, the number of ROs of the set is equal to the number of the PRACH repetition. As shown in FIG. 8, a SSB mapping to the ROs for a PRACH repetition within the ROs resources. In some embodiments, when more than one beam is mapped to a set of ROs, different PRACH preamble sets can be used to indicate the SSB information.

In this case, SS/PBCH block (SSB) indexes provided by ssb-PositionsInBurst in SIB1 or in ServingCellConfigCommon are mapped to valid PRACH occasions in the following order:
First, in increasing order of time resource indexes for time multiplexed PRACH occasions within a PRACH slot;
Second, in increasing order of indexes for PRACH slots
Third, in increasing order of preamble indexes within a single PRACH occasion
Fourth, in increasing order of frequency resource indexes for frequency multiplexed PRACH occasions;

Alternatively,
First, in increasing order of time resource indexes for time multiplexed PRACH occasions within a PRACH slot;
Second, in increasing order of indexes for a set of PRACH slots
Third, in increasing order of frequency resource indexes for frequency multiplexed PRACH occasions
Fourth, in increasing order of preamble indexes within a single PRACH occasion;

Alternatively,
First, in increasing order of time resource indexes for time multiplexed PRACH occasions within a PRACH slot or a set of slots;
Second, in increasing order of indexes for PRACH slots
Third, in increasing order of preamble indexes within a single PRACH occasion
Fourth, in increasing order of frequency resource indexes for frequency multiplexed PRACH occasions;
Fifth, cycling of the above four step within the remaining PRACH slots within a PRACH periodicity;

Alternatively,
First, in increasing order of time resource indexes for time multiplexed PRACH occasions within a PRACH slot;
Second, in increasing order of indexes for a set of PRACH slots
Third, in increasing order of frequency resource indexes for frequency multiplexed PRACH occasions
Fourth, in increasing order of preamble indexes within a single PRACH occasion
Fifth, cycling of the above four steps within the remaining PRACH slots within a PRACH periodicity.

Commercial interests for some embodiments are as follows. 1. Solving issues in the prior art. 2. Realizing cell coverage enhancement. 3. Providing a good communication performance. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

The embodiment of the present application further provides a computer readable storage medium for storing a computer program. The computer readable storage medium enables a computer to execute corresponding processes implemented by the UE/BS in each of the methods of the embodiments of the present application. For brevity, details will not be described herein again.

The embodiment of the present application further provides a computer program product including computer program instructions. The computer program product enables a computer to execute corresponding processes implemented by the UE/BS in each of the methods of the embodiments of the present application. For brevity, details will not be described herein again.

The embodiment of the present application further provides a computer program. The computer program enables a computer to execute corresponding processes implemented by the UE/BS in each of the methods of the embodiments of the present application. For brevity, details will not be described herein again.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware of software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A wireless communication method, performed by a user equipment (UE), the method comprising:
notifying a base station of beam information by associating the beam information with multiple physical random access channel (PRACH) transmission or random access channel (RACH) resources of the multiple PRACH transmission.

2. The method of claim 1, wherein the beam information comprises beam index.

3. The method of claim 1, wherein the beam information is indicated by time/frequency resources of RACH occasions (ROs) of the multiple PRACH transmission.

4. The method of claim 3, wherein a mapping rule between the ROs and the beam information is pre-defined.

5. (canceled)

6. The method of claim 1, wherein the beam information is associated with the number of repetition of the multiple PRACH transmissions.

7. The method of claim 6, wherein the number of the multiple PRACH transmissions are equal to the number of beams, and a location of repetition or a repetition number within the multiple PRACH transmission is used to indicate a beam index of the beam information.

8. The method of claim 1, wherein the beam information is determined based on a RO group, which is determined based on a number of repetition of the multiple PRACH transmission and the number of beams.

9. The method of claim 1, wherein the ROs and/or preambles for the multiple PRACH transmissions are used to indicate UE capacity.

10. The method of claim 1, further comprising:
receiving a signalling used to notify the UE that the multiple PRACH transmission with more than one beam is enabled.

11. The method of claim 1, further comprising:
being notified by the base station of an index of a beam by at least one of the following:
a field in random access response (RAR);
random access (RA)-radio network temporary identifier (RNTI);
demodulation reference signal (DMRS) of RAR; or
time domain resource allocation (TDRA) in downlink control information (DCI) of RAR or TDRA of Msg 3 or modulation and coding scheme (MCS) field of Msg 3.

12. A wireless communication method, performed by a user equipment (UE), the method comprising:
notifying a base station of the number of repetition of multiple physical random access channel (PRACH) transmission; or
determining a random access response (RAR) window based on the multiple PRACH transmission.

13. The method of claim 12, wherein the number of repetition of the multiple PRACH transmission is indicated based on random access channel (RACH) occasion (RO) resources of the multiple PRACH transmission.

14.-15. (canceled)

16. The method of claim 12, wherein the number of repetition of the multiple PRACH transmission is indicated based on RACH preamble, the RACH preambles used for the multiple PRACH transmission are split into a plurality of groups, and each group of the RACH preambles is associated with one level of repetition of the multiple PRACH transmission.

17. (canceled)

18. The method of claim 12, wherein the number of repetition of the multiple PRACH transmission is indicated based on both RACH preamble and RO resources of the multiple PRACH transmission.

19.-20. (canceled)

21. A wireless communication method, performed by a user equipment (UE), the method comprising:
transmitting multiple physical random access channel (PRACH) transmission on random access channel (RACH) occasions (ROs), wherein a synchronization signal/physical broadcast channel (PBCH) block (SSB) index is mapped to a set ROs with different time domain entity.

22. The method of claim 21, wherein the SSB index is mapped to the set of time domain ROs with same or different frequency domain resources.

23. The method of claim 21, wherein the SSB index is mapped to whole time domain ROs of the multiple PRACH transmission within a RACH configuration or a RACH periodic.

24. (canceled)

25. The method of claim 21, wherein SSB indexes are mapped to valid PRACH occasions in the following order:
first, in increasing order of time resource indexes for time multiplexed PRACH occasions within a PRACH slot;
second, in increasing order of indexes for PRACH slots;
third, in increasing order of preamble indexes within a single PRACH occasion;
fourth, in increasing order of frequency resource indexes for frequency multiplexed PRACH occasions.

26.-27. (canceled)

28. A wireless communication method, performed by a base station (BS), the method comprising:
being notified of beam information by associating the beam information with multiple physical random access channel (PRACH) transmission or random access channel (RACH) resources of the multiple PRACH transmission.

29.-38. (canceled)

39. A wireless communication method, performed by a base station (BS), the method comprising:
being notified of the number of repetition of multiple physical random access channel (PRACH) transmission; or,
determining a random access response (RAR) window based on the multiple PRACH transmission.

40.-45. (canceled)

46. A wireless communication method, performed by a base station (BS), the method comprising:
receiving multiple physical random access channel (PRACH) transmission on random access channel (RACH) occasions (ROs), wherein a synchronization signal/physical broadcast channel (PBCH) block (SSB) index is mapped to a set ROs with different time domain entity.

47.-58. (canceled)
